(19) United States
(12) Patent Application Publication
(10) Pub. No.: US 2017/0163121 A1
(43) Pub. Date: Jun. 8, 2017

(54) ROTOR OF WOUND ROTATE SYNCHRONOUS MOTOR

(71) Applicant: Hyundai Motor Company, Seoul (KR)

(72) Inventors: Sangjin Park, Hwaseong (KR); Hyoungjun Cho, Suwon (KR); Yongsung Jang, Hwaseong (KR)

(21) Appl. No.: 15/244,482

(22) Filed: Aug. 23, 2016

(30) Foreign Application Priority Data
Dec. 2, 2015 (KR) 10-2015-0170974

(51) Int. Cl. H02K 3/52; H02K 13/02; H02K 13/00

(52) U.S. Cl. CPC H02K 3/527; H02K 13/003; H02K 13/02

(57) ABSTRACT

A rotor of a WRSM motor is provided. The rotor of the WRSM motor includes a rotor body that has a rotary shaft joined to the center thereof and wound with a rotor coil and a slip ring module that is installed on an end of the rotary shaft to slidably move in an axial direction of the rotary shaft and that is electrically connected with a connection end of the rotary coil. A pair of first connectors is installed in the slip ring module to protrude toward the rotary body and a pair of second connectors is installed to connect the rotor body and the connection end of the rotor coil and is connected with the first connectors by a female and male connection method.

### CROSS-REFERENCE TO RELATED APPLICATION

This application claims priority to and the benefit of Korean Patent Application No. 10-2015-0170974 filed in the Korean Intellectual Property Office on Dec. 2, 2015, the entire contents of which are incorporated herein by reference.

### BACKGROUND

(a) Field of the Invention

An exemplary embodiment of the present invention relates to a rotor of a wound rotate synchronous motor (WRSM), and more particularly to a WRSM rotor that enhances an electric connection structure of a slip ring and rotor coils and reduces the length of a motor.

(b) Description of the Related Art

In general, a hybrid vehicle or an electric vehicle called an environmentally-friendly vehicle is driven by an electric motor (hereinafter, referred to as a “driving motor”) that obtains rotary force with electric energy. The hybrid vehicle is driven in an electric vehicle (EV) mode which is a pure electric vehicle mode using power of the driving motor or driven in a hybrid electric vehicle (HEY) mode using both the rotary force of an engine and the rotary force of the driving motor as the power. In addition, a general electric vehicle is driven using the rotary force of the driving motor as the power.

As described above, for the driving motor used as a power source of the environmentally-friendly vehicle, a permanent magnet synchronous motor (PMSM) is often used. The performance of a permanent magnet should be maximized for the permanent magnet synchronous motor (PMSM) to show the maximum performance under a limited layout condition. Herein, a neodymium (Nd) constituent of the permanent magnet enhances the intensity of the permanent magnet and a dysprosium (Dy) constituent enhances high-temperature demagnetization endurance. However, such rare earth metal (Nd and Dy) constituents of the permanent magnet are limited and expensive and are significant in price fluctuation.

Accordingly, in recent years, application of an induction motor has been reviewed, but there is a limit in that size increment amounts of sizes including a volume, a weight, and the like are excessive to show the same motor performance. In recent years, development of a wound rotor synchronous motor (WRSM) as a driving motor to be used for a power source of the vehicle has been conducted to replace the PMSM. When current is applied to a rotor as well as a stator by winding coils, the rotor is electromagnetized, and as a result, the wound rotor synchronous motor (WRSM) has been substituted for the permanent magnet synchronous motor (PMSM).

The wound rotor synchronous motor (WRSM) as a structure in which the rotor acquired by winding rotor coils is disposed spaced apart from the stator with a predetermined gap can generate magnetic flux by applying the current to the rotor coils through a brush and a slip ring. Meanwhile, the rotor of the wound rotor synchronous motor (WRSM) includes a rotor core wound with the rotor coils. The rotor core is joined with a rotary shaft. The slip ring is installed on the end of the rotary shaft. In addition, the brush contacts the slip ring which rotates by the rotary shaft and applies direct current (DC) to the rotary coils. In the rotor of the wound rotor synchronous motor (WRSM), the slip ring is electrically connected with the rotor coils via a fusing terminal. The fusing terminal may be compressed by a fusing machine while supporting positive (+) and negative (−) connection terminals of the rotor coils and joined with the rotor coils by resistance welding.

A sufficient working space in which parts of the rotor do not interfere with the fusing machine must be secured to fuse the fusing terminal and the connection terminal of the rotor core using the fusing machine. Therefore, in the related art, to secure the sufficient working space, the entire length of the driving motor, furthermore, the entire length of a motor driving system is unavoidably increased. Further, in the related art, when the rotor rotates rapidly, by centrifugal force applied to a fusing portion where the fusing terminal and the connection terminals of the rotor coils are fusing-connected, the fusing portion may be damaged, and as a result, a failure and durability deterioration of the motor may be caused.

The above information disclosed in this section is merely for enhancement of understanding of the background of the invention and therefore it may contain information that does not form the prior art that is already known in this country to a person of ordinary skill in the art.

### SUMMARY

The present invention provides a rotor of a WRSM which may eliminate a fusing operation for fusing-connecting a fusing terminal of a slip ring and rotor coils by enhancing an electric connection structure of the slip ring and the rotor coils and may reduce the length of a motor. The present invention also provides a rotor structure of a WRSM which may prevent an electric connector of the slip ring from being damaged due to centrifugal force depending on rapid rotation.

An exemplary embodiment of the present invention provides a rotor structure of a WRSM motor that may include: a rotor body having a rotary shaft joined to the center thereof and wound with a rotor coil; a slip ring module installed on an end of the rotary shaft to slidably move in an axial direction of the rotary shaft and electrically connected with a connection end of the rotary coil; a pair of first connectors installed in the slip ring module to protrude toward the rotary body; and a pair of second connectors installed to connect the rotor body and the connection end of the rotor coil and connected with the first connectors by a female and male connection method.

The first connector may include a terminal pin as a conductive plate having a predetermined width and a predetermined thickness and is conductible. The second connector may include a connector body into which the terminal pin may be inserted and electrically connected with the terminal pin. The connector body may be a conductive plate having a predetermined width and bent to insert the terminal pin. A guide rail may be formed on the outer periphery of the rotary shaft in the axial direction. The connector body may include a connection terminal into which the terminal pin may be inserted, and round shaped convex portions of the connection terminals may be provided to contact while facing each other and elastically deformed by the terminal pin. The terminal pin may include a connection end curved in an oval shape. The connector body may include the connection terminal into which the terminal pin may be inserted, and portions of the connection terminals, which face each other may be spaced apart from each other in a “ [symbol] ” shape and elastically deformed by the connection end.

Another exemplary embodiment of the present invention provides a rotor structure of a WRSM motor that may include: a rotor body having a rotary shaft joined to the center thereof and wound with a rotor coil; and a slip ring module installed on the end of the rotary shaft to slidably move in an axial direction of the rotary shaft and electrically connected with a connection end of the rotary coil, wherein the slip ring module may include a brush contact portion contacting a brush and a ring type terminal mounting portion connected with the brush contact portion, a pair of first connectors may be installed in the terminal mounting portion to protrude toward the rotor body, and second connectors connected with the first connectors by a female and male connection method may be installed in the rotor body to be connected with a connection end of the rotor coil.

The first connector may include a terminal pin as a conductive plate having a predetermined width and a predetermined thickness and is conductible. The second connector may include a connector body installed in a bobbin of the rotor body, connected with the connection end of the rotor coil, and electrically connected with the terminal pin. The connector body may be a conductive plate having a predetermined width and bent to insert the terminal pin. Additionally, the connector body may include the connection terminal into which the terminal pin may be inserted, and the connection terminal may be elastically deformed by the terminal pin. The connector body may include the connection terminal into which the terminal pin may be inserted, and round shaped convex portions of the connection terminals may be provided to contact while facing each other and elastically deformed by the terminal pin. The terminal pin may include a connection end curved in an oval shape, the connector body may include the connection terminal into which the terminal pin may be inserted, and portions of the connection terminals, which face each other may be spaced apart from each other in a “ [symbol] ” shape and elastically deformed by the connection end.

According to exemplary embodiments of the present invention, since first and second connectors may be connected by sliding and a female and male connection method and a slip ring module and connection terminals of rotor coils may be electrically connected with each other, a fusing operation for fusing-connecting a fusing terminal of a slip ring and the rotor coils may be omitted and an expensive fusing equipment may be omitted, and as a result, manufacturing cost of a motor and initial facility investment cost may be reduced.

Further, in the exemplary embodiments of the present invention, since a fusing operation space in which a fusing machine and rotor components do not interfere with each other as in the related art need not be secured, the length of the motor may be reduced and, the whole length of a motor driving system may be reduced. In addition, in the exemplary embodiments of the present invention, unlike the related art where fusing-connects the fusing terminal and the connection terminals of the rotor coils, the fusing terminal and the connection terminals of the rotor coils may be connected to each other by the first and second connectors by the female and male connection method, and thus, the potential risk that an electric connector of the slip ring module and the rotor coils will be damaged due to centrifugal force may be eliminated.

### BRIEF DESCRIPTION OF THE DRAWINGS

The drawings are used for reference in describing exemplary embodiments of the present invention and thus, the technical spirit of the present invention should not be analyzed to be limited to the accompanying drawings.

FIGS. 1A and 1B are diagrams illustrating a rotor of a WRSM motor according to an exemplary embodiment of the present invention;

FIG. 2 is a diagram schematically illustrating a first connector applied to the rotor of the WRSM motor according to the exemplary embodiment of the present invention;

FIG. 3 is a diagram schematically illustrating a second connector applied to the rotor of the WRSM motor according to the exemplary embodiment of the present invention.

FIG. 4 is a diagram illustrating a first implementation example of the first and second connectors applied to the rotor of the WRSM motor according to the exemplary embodiment of the present invention; and

FIG. 5 is a diagram illustrating a second implementation example of the first and second connectors applied to the rotor of the WRSM motor according to the exemplary embodiment of the present invention.

### DESCRIPTION OF SYMBOLS

1: Rotor coil

1a: positive (+) and negative (−) connection terminals

3: Rotary shaft

4: Guide rail

7: Bobbin

9: Brush

10: Rotor body

20: Slip ring module

21: Brush contact portions

23: Terminal mounting portion

30: First connector

31: Terminal pin

33: Connection end

50: Second connector

51: Connector body

53: Connection terminal

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention. The drawings and description are to be regarded as illustrative in nature and not restrictive and like reference numerals designate like elements throughout the specification.

Since size and thickness of each component illustrated in the drawings are arbitrarily represented for convenience in explanation, the present invention is not particularly limited to the illustrated size and thickness of each component and the thickness is enlarged and illustrated in order to clearly express various parts and areas. In addition, in the following detailed description, names of components, which are in the same relationship, are divided into “the first”, “the second”, and the like to distinguish the components, but the present invention is not limited to the order. In addition, “unit”, “means”, “part”, “member”, or the like, which is described in the specification, means a unit of a comprehensive configuration that performs at least one function or operation.

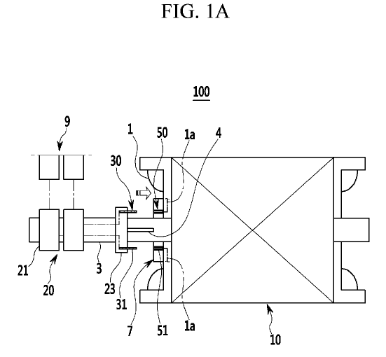

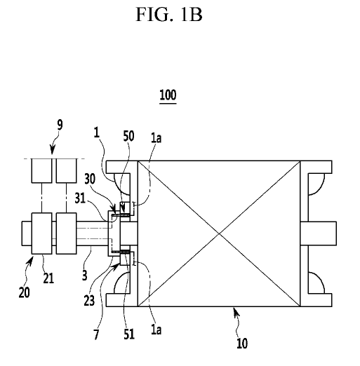

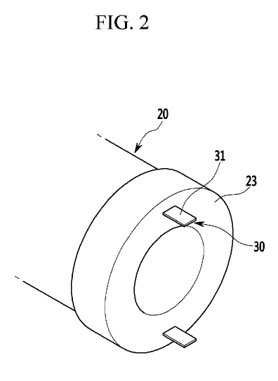

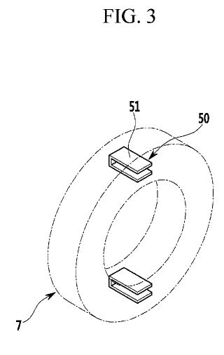

FIGS. 1A and 1B are diagrams illustrating a rotor of a WRSM motor according to an exemplary embodiment of the present invention. The exemplary embodiment of the present invention may be applied to a wound rotor synchronous motor (WRSM) as a motor device configured to obtain drive force with electric energy in environmentally-friendly vehicles (e.g., a hybrid vehicle, an electric vehicle, a fuel cell vehicle, and the like). Referring to FIGS. 1A and 1B, the WRSM according to the exemplary embodiment of the present invention may include a stator (not illustrated) wound with a stator coil (not illustrated) and a rotor 100 wound with a rotor coil 1 and disposed inside the stator.

A rotary shaft 3 may be joined to the center of the rotor 100 and an outer surface of the rotor 100 may be disposed inside the stator while being spaced apart form an inner diameter surface of the stator with a predetermined gap. In the WRSM, when current is applied to the rotor 100 as well as the stator by winding the rotor coil 1, the rotor 100 may be electromagnetized and drive torque may be generated by attraction force and repulsive force between the rotor 100 and the stator. The rotor 100 according to the exemplary embodiment of the present invention applied to the WRSM may include a rotor body 10 and a slip ring module 20.

The rotor body 10 may be rotatably installed inside the stator with a predetermined gap. The rotary shaft 3 may be joined to the center of the rotor body 10. Both ends of the rotary shaft 3 may protrude toward both sides of the rotor body 10. Additionally, a plurality of bearings (not illustrated) may be installed at both protrusion portions of the rotary shaft 3. The rotor body 10 may include a rotor core disposed in an axial direction of the rotary shaft 3. The rotor coil 1 may be wound around the rotor core.

Further, plastic-made bobbins 7 which support the rotor coil 1 may be installed at both ends of the rotor body 10 and end caps (not illustrated) that cover both ends thereof may be provided. The bobbin 7 and the end cap are components constituting the rotor body 10 and in the exemplary embodiment of the present invention, the components may be collectively referred to as the rotor body 10 except for an exceptional case. The slip ring module 20 may be fixedly installed at one protrusion end of the rotary shaft 3 and electrically connected with positive (+) and negative (−) connection terminals 1a of the rotor coil 1. The slip ring module 20 may be configured to provide DC current applied through a brush 9 to the rotor coil 1 through the positive (+) and negative (−) connection terminals 1a.

The brush 9 may contact the slip ring module 20 configured to rotate together with the rotary shaft 3 and may be configured to apply the DC current to the rotor coil 1 through the slip ring module 20. The brush 9 may be closely attached to (e.g., proximate to or adjacent to) the slip ring module 20 by elastic force of a spring. The slip ring module 20 may include a brush contact portion 21 and a terminal mounting portion 23. The brush contact portion 21 to which the brush 9 is attached may have a cylindrical shape and may be fixed to one protrusion end of the rotary shaft 3. The terminal mounting portion 23 as a ring type may be integrally connected with the brush contact portion 21 and fixed to the rotary shaft 3. Herein, the terminal mounting portion 23 may be electrically connected with the positive (+) and negative (−) connection terminals 1a of the rotor coil 1 by first and second connectors 30 and 50 to be described later.

The slip ring module 20 may be installed on the end of the rotary shaft 3 to slidably move in the axial direction of the rotary shaft 3. For example, the slip ring module 20 may be installed on the outer periphery of the rotary shaft 3 to slidably move through a guide rail 4 formed in the axial direction of the rotary shaft 3. The rotor 100 of the WRSM according to the exemplary embodiment of the present invention has a structure in which a fusing operation for fusing-connecting a fusing terminal of a slip ring and the rotor coil in the related may be omitted and the length (e.g., overall length) of a motor may be reduced.

Furthermore, in the exemplary embodiment of the present invention, the rotor 100 of the WRSM may prevent an electric connector of the slip ring module 20 from being damaged due to centrifugal force depending on rapid rotation by enhancing an electric connection structure of the slip ring and the rotor coil in the related art. Accordingly, the rotor 100 of the WRSM according to the exemplary embodiment of the present invention may include a pair of first connectors 30 and a pair of second connectors 50 for electrically connecting the slip ring module 20 and the positive (+) and negative (−) connection terminals 1a of the rotor coil 1.

The first and second connectors 30 and 50 may be connection connectors connected by a female and male connection method, and as a result, the slip ring module 20 and the positive (+) and negative (−) connection terminals 1a of the rotor coil 1 may be electrically connected with each other. The first connector 30 may be provided as a male type connection terminal installed at the terminal mounting portion 23 of the slip ring module 20 to protrude toward a winding portion of the rotor coil 1 of the rotor body 10 as a pair of positive (+) and negative (−) connection terminals.

Further, the first connector 30 may include a terminal pin 31 disposed in the terminal mounting portion 23 of the slip ring module 20 to protrude toward the second connector 50 to be described later. The terminal pin 31 may be provided as a conductive plate having a predetermined width and a predetermined thickness and may be conductible, fixedly installed in the terminal mounting portion 23, and electrically connected with the brush contact portion 21 through the terminal mounting portion 23. The second connector 50 may be provided as a female type connection terminal, installed in the rotor body 10 to be connected with the positive (+) and negative (−) connection terminals 1a of the rotor coil 1 as a pair of positive (+) and (−) negative connection terminals, and provided to be connected with the terminal pin 31 of the first connector 30 by the female and male connection method.

For example, the second connector 50 may be fixedly installed in the bobbin 7 of the rotor body 10 to correspond to the terminal mounting portion 23 of the slip ring module 20. The second connector 50 may include a connector body 51 connected with the positive (+) and negative (−) connection terminals 1a of the rotor coil 1. The second connector 50 may be provided in a shape in which the terminal pin 31 of the first connector 30 may be inserted into the connector body 51 and the second connector 51 may be electrically connected with the terminal pin 31, and as a result, the second connector 50 may be formed as a conductive plate having a predetermined width and a predetermined thickness and bent to insert the terminal pin 31.

A process of manufacturing the rotor 100 of the WRSM according to the exemplary embodiment of the present invention, which is configured as above will be described below. The slip ring module 20 may be configured to move to the end of rotary shaft 3 along the guide rail 4 of the rotary shaft 3. The first connector 30 may be configured in the terminal mounting portion 23 of the slip ring module 20 and the second connector 50 connected with the positive (+) and negative (−) connection terminals 1a of the rotor coil 1 may be configured in the bobbin 7 of the rotor body 10. Accordingly, in the exemplary embodiment of the present invention, the slip ring module 20 may be configured to slidably move to the bobbin 7 of the rotor body 10 along the guide rail 4 of the rotary shaft 3.

The terminal pin 31 of the first connector 30 may be inserted into the connector body 51 of the second connector 50 positioned at the bobbin 7 side. In other words, the terminal pin 31 and the connector body 51 of the first and second connectors 30 and 50 may be connected to each other by the female and male connection method and the slip ring module 20 and the positive (+) and negative (−) connection terminals 1a of the rotor coil 1 may be electrically connected with each other through the terminal pin 31 and the connector body 51.

Herein, the first and second connectors 30 and 50 may be bound by joining force to prevent the first and second connectors 30 and 50 from being separated from each other by the centrifugal force when the rotor 100 rotates rapidly. Additionally, the first and second connectors 30 and 50 may be solidly fixed to each other by resin molding. An example in which the first connector 30 is configured in the slip ring module 20 and the second connector 50 is configured in the bobbin 7 of the rotor body 10 as a female and male connection terminal structure is described in the exemplary embodiment of the present invention as described above, but the present invention is not limited thereto and the first connector 30 may be configured in the bobbin 7 of the rotor body 10 and the second connector 50 may be configured in the slip ring module 20.

According to the rotor 100 of the WRSM according to the exemplary embodiment of the present invention described above, the first and second connectors 30 and 50 may be connected with each other by sliding and the female and male connection method and the slip ring module 20 and the positive (+) and negative (−) connection terminals 1a of the rotor coil 1 may be electrically connected with each other. Therefore, since the fusing operation for fusing-connecting the fusing terminal and the rotor coil in the related art may be omitted in the exemplary embodiment of the present invention, an expensive fusing equipment may be eliminated, and as a result, manufacturing cost of the motor and initial facility investment cost may be reduced.

Further, in the exemplary embodiment of the present invention, since a fusing operation space in which a fusing machine and rotor components do not interfere with each other like the related art need not be secured, the length of the motor may be reduced and furthermore, the whole length of a motor driving system may be reduced. In addition, in the exemplary embodiment of the present invention, unlike the related art that fusing-connects the fusing terminal and the connection terminals of the rotor coils, the fusing terminal and the connection terminals of the rotor coils may be connected to each other through the first and second connectors 30 and 50 by the female and male connection method, the slip ring module 20 and the electric connector of the rotor coil 1 may not be damaged by the centrifugal force.

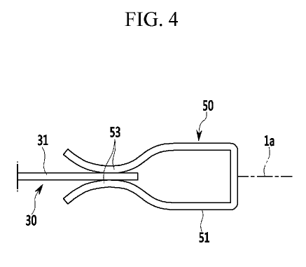

FIG. 4 is a diagram illustrating a first implementation example of first and second connectors applied to the rotor of the WRSM motor according to the exemplary embodiment of the present invention. When the first implementation example of the first and second connector 30 and 50 applied to the rotor of the WRSM according to the exemplary embodiment of the present invention is described with reference to FIG. 4, the terminal pin 31 of the first connector 30 may be provided in a linear form having a predetermined width and a predetermined thickness. In addition, the connector body 51 of the second connector 50 may include a connection terminal 53 into which the terminal pin 31 of the first connector 30 may be inserted.

Herein, the connection terminal 53 of the connector body 51 may be elastically deformed by the terminal pin 31 and for example, round shaped convex portions may be provided to contact each other. Therefore, in the present implementation example, when the terminal pin 31 is inserted into and connected to the connection terminal 53 of the connector body 51, the connection terminal 53 may be elastically deformed by the terminal pin 31 and the terminal pin 31 may be solidly bound to the round shaped convex portion by elastic force. As a result, in the present implementation example, since the terminal pin 31 connected to the connection terminal 53 of the connector body 51 may be solidly bound in a shape of the connection terminal 53, binding force of the first connector 30 to the second connector 50 may further increase and negative effects such when the first and second connectors 30 and 50 are short-circuited by the centrifugal force, and the like may be solved.

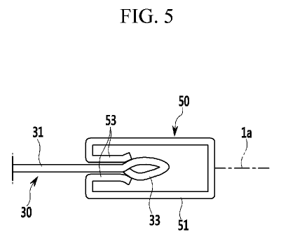

FIG. 5 is a diagram illustrating a second implementation example of the first and second connectors applied to the rotor of the WRSM motor according to the exemplary embodiment of the present invention. When the second implementation example of the first and second connector 30 and 50 applied to the rotor of the WRSM according to the exemplary embodiment of the present invention is described with reference to FIG. 5, the terminal pin 31 of the first connector 30 may be provided as the conductive plate having a predetermined width and a predetermined thickness, and as a result, the terminal pin 31 of the first connector 30 may include a connection end 33 which is curved in an oval shape. In addition, the connector body 51 of the second connector 50 may include the connection terminal 53 into which the terminal pin 31 of the first connector 30 may be inserted.

Herein, portions of the connection terminals 53 of the connector body 51 which face each other may be spaced apart from each other in a “ [symbol] ” shape and the connection terminal 53 may be provided to be elastically deformed by the connection end 33 of the terminal pin 31. Therefore, in the present implementation example, when the terminal pin 31 is inserted into and connected to the connection terminal 53 of the connector body 51, the connection end 33 may be suspended to a “ [symbol] ” shaped portion of the connection terminal 53 and the terminal end 33 of the terminal pin 31 may be solidly bound by the elastic force of the connection terminal 53. As a result, in the present implementation example, since the connection end 33 of the terminal pin 31 connected to the connection terminal 53 of the connector body 51 may be solidly bound in the shape of the connection terminal 53, the binding force of the first connector 30 to the second connector 50 may further increase and the negative effects such as when the first and second connectors 30 and 50 are short-circuited by the centrifugal force, and the like may be solved.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

12

What is claimed is:

1. A rotor of a wound rotate synchronous motor (WRSM), comprising:
a rotor body having a rotary shaft joined to the center thereof and wound with a rotor coil;
a slip ring module installed on an end of the rotary shaft to slidably move in an axial direction of the rotary shaft and electrically connected with a connection end of the rotor coil;
a pair of first connectors installed in the slip ring module to protrude toward the rotary body; and
a pair of second connectors installed to connect the rotor body and the connection end of the rotor coil and connected with the first connectors by a female and male connection method.

2. The rotor of claim 1, wherein the first connector includes a terminal pin as a conductive plate having a predetermined width and a predetermined thickness and is conductible.

3. The rotor of claim 2, wherein the second connector includes a connector body into which the terminal pin is inserted and electrically connected with the terminal pin.

4. The rotor of claim 3, wherein the connector body is a conductive plate having a predetermined width and bent to receive the terminal pin.

5. The rotor of claim 3, wherein a guide rail is formed on the outer periphery of the rotary shaft in the axial direction.

6. The rotor of claim 3, wherein the connector body includes a connection terminal into which the terminal pin is inserted, and round shaped convex portions of the connection terminals are provided to contact while facing each other and elastically deformed by the terminal pin.

7. The rotor of claim 3, wherein the terminal pin includes a connection end curved in an oval shape.

8. The rotor of claim 7, wherein the connector body includes the connection terminal into which the terminal pin is inserted, and portions of the connection terminals, which face each other are spaced apart from each other in a “ [symbol] ” shape and elastically deformed by the connection end.

9. A rotor of a wound rotate synchronous motor (WRSM), comprising:
a rotor body having a rotary shaft joined to the center thereof and wound with a rotor coil; and
a slip ring module installed on an end of the rotary shaft to slidably move in an axial direction of the rotary shaft and electrically connected with a connection end of the rotor coil,
wherein the slip ring module includes:
a brush contact portion that contacts a brush and a ring type terminal mounting portion connected with the brush contact portion,
a pair of first connectors installed in the terminal mounting portion to protrude toward the rotor body, and
a pair of second connectors connected with the first connectors by a female and male connection method and installed in the rotor body to be connected with the connection end of the rotor coil.

10. The rotor of claim 9, wherein the first connector includes a terminal pin as a conductive plate having a predetermined width and a predetermined thickness and is conductible.

11. The rotor of claim 10, wherein the second connector includes a connector body installed in a bobbin of the rotor body, connected with the connection end of the rotor coil, and electrically connected with the terminal pin.

12. The rotor of claim 11, wherein the connector body is a conductive plate having a predetermined width and bent to receive the terminal pin.

13. The rotor of claim 12, wherein the connector body includes the connection terminal into which the terminal pin is inserted, and the connection terminal is elastically deformed by the terminal pin.

14. The rotor of claim 11, wherein the connector body includes the connection terminal into which the terminal pin is inserted, and round shaped convex portions of the connection terminals are provided to contact while facing each other and elastically deformed by the terminal pin.

15. The rotor of claim 11, wherein the terminal pin includes a connection end curved in an oval shape, the connector body includes the connection terminal into which the terminal pin is inserted, and, portions of the connection terminals, which face each other are spaced apart from each other in a “ [symbol] ” shape and elastically deformed by the connection end.
